(19) United States
(12) Patent Application Publication
(10) Pub. No.: US 2015/0283637 A1
(43) Pub. Date: Oct. 8, 2015

(54) DEVICE AND METHOD FOR PRINTING A THIXOTROPIC MEDIUM ONTO A PCB

(71) Applicants: Robert GRAY, Buford, GA (US); Gabriel de Jesus PARDAVE, Zapopan (MX)

(72) Inventors: Robert GRAY, Buford, GA (US); Gabriel de Jesus PARDAVE, Zapopan (MX)

(21) Appl. No.: 14/245,401

(22) Filed: Apr. 4, 2014

(51) Int. Cl. B23K 3/06; B23K 31/02; B23K 37/00; B23K 1/00; B23K 1/20

(52) U.S. Cl. CPC B23K 3/0638; B23K 1/0016; B23K 1/20; B23K 37/00; B23K 31/02; B23K 2201/42

(57) ABSTRACT

A device for printing a thixotropic medium onto a PCB comprising a printing head adapted to apply the thixotropic medium to a surface of the PCB is characterized in that the device further comprises a surface area where the thixotropic medium is locatable to be repeatably worked upon in a kneading operation during which at least a part of the thixotropic medium is kneaded while the printing head is not in use for applying the thixotropic medium onto the PCB.

### FIELD OF THE INVENTION

The present invention relates to a device for printing a thixotropic medium, such as a solder paste, onto a printed circuit board (PCB), the device comprising a printing head adapted to apply the thixotropic medium to a surface of the PCB. The invention relates further to a method for printing a thixotropic medium, such as a solder paste, onto a PCB using such a printing head.

### BACKGROUND AND PRIOR ART

An example of a printing device being adapted for applying a print medium such as a solder paste onto selected areas of a PCB using a screen is disclosed in US patent publication number 2010/0139509 A1.

The printing device disclosed therein comprises a printing head, which can be driven in a reciprocal movement within a support during a printing operation. The printing head comprises a delivery aperture through which the solder paste is delivered from a cavity, in which the solder paste is stored. A rotatable unit is positioned within the cavity, which, when being driven by a drive unit, displaces the solder paste within the cavity in order to apply a flow direction component to the flow of solder paste which is opposite to the direction of displacement of the printing head during the printing operation. This is done to avoid incomplete filling of printing apertures formed by the printing screen. Further, the stirring of the solder paste by means of the rotating unit leads to an even consistency of the solder paste.

Solder pastes which are printed onto PCBs usually comprise powdered metal solder suspended in a thick medium called flux. It usually has a thixotropic characteristic. Thus, its viscosity is reduced by exposing it continuously to mechanical stress. The thixotropic characteristic facilitates the application of the solder paste when it is in a state of low viscosity by means of a printer head, and further ensures that the discrete amounts of the solder paste stays in place once it is applied to the PCB and its viscosity increases.

Nevertheless, the thixotropic characteristic of the solder paste represents a problem if the time elapsed between the printing of two successive PCBs on a printing line using the same printing head is too long and thus the solder paste within the printing head transforms into a state of relatively high viscosity. This may have a negative effect on the printing quality of the second PCB. Usually the timing between printing of two successive PCBs on a printing line is short enough to avoid transformation of the solder paste into a state of high viscosity which represents a problem for the printing of the subsequent PCB. Nevertheless, this may not be the case if the printing line suffers a downtime, e.g. due to a technical failure in upstream or downstream processes. Such a downtime usually has a duration that will result in such transformation of the solder paste into a state of high viscosity, thereby affecting the printing quality of the subsequent PCBs printed after resumption of the printing process.

### SUMMARY OF THE INVENTION

It is an object of the present invention to overcome the aforesaid disadvantages. In particular it is an aim of the present invention to provide a device and a method for printing a thixotropic medium onto a PCB, which avoids quality issues due to transformation of the thixotropic medium into a relatively high viscous state during a downtime of a printing line.

This objective is achieved by a device for printing a thixotropic medium onto a PCB according to claim 1 and a respective method according to claim 7. Preferred embodiments of the claimed invention are subject to the further claims and are described in the following specification of the invention and the appending drawings. The features and details discussed with respect to the device for printing a thixotropic medium onto a PCB can of course also be combined with features and details discussed in relation to the method for printing a thixotropic medium onto a PCB and vice versa.

In one aspect the invention provides a device for printing a thixotropic medium, in particular a solder paste, onto a printed circuit board (PCB), the device comprising a printing head adapted to apply (in particular spread) the thixotropic medium to a surface of the PCB, in particular through a printing screen, whereas the device further comprises a surface area where the thixotropic medium is locatable to be repeatedly worked upon in a kneading operation during which at least a part of the thixotropic medium is kneaded while the printing head is not in use for applying the thixotropic medium onto the PCB. A PCB does not have to be present in the device and in particular underneath the printing screen while the kneading operation is executed.

Thus, the invention is directed to performing a kneading operation while the printing head is not in use for applying the thixotropic medium to the PCB (a PCB does not have to be present in the device during the kneading operation), which may in particular be the case during a downtime of a printing line in which the device is used. Such a printing line may further comprise a conveyer or any other transportation means useable for transporting PCBs successively into the working range of the device. The kneading operation will avoid transformation of the thixotropic medium into a state with such a high viscosity that may affect the quality of the subsequent PCBs printed after the end of the downtime. Thus, printing or applying the thixotropic medium to the PCB may start right after the end of the downtime and as soon as a PCB is present in the device.

In a further aspect the invention is directed to a respective method for printing a thixotropic medium, in particular a solder paste, onto a PCB using a printing head adapted to apply the thixotropic medium to a surface of the PCB, wherein at least a part of the thixotropic medium is repeatedly worked upon at a surface area on which the thixotropic medium is locatable in a kneading operation while the printing head is not used for applying the solder paste onto the PCB (a PCB does not have to be present in the device during the kneading operation). The kneading is preferably done automatically, in particular fully automatically, i.e. without a manual activation of the kneading operation, by means of the printing head.

In a preferred embodiment of the claimed device, a timer is provided, which is adapted to start a kneading operation after the lapse of a predefined period of time during which the printing head was not used for applying the thixotropic medium to a PCB. In a respective embodiment of the claimed method the kneading operation is started after the lapse of a predefined period of time during which the printing head was not used for printing a PCB. This may ensure that a kneading operation will only be conducted if the printing head has not been used for applying the thixotropic medium to a PCB for a predefined period of time, in which an undesirable increase in the viscosity of the thixotropic medium is to be expected.

As the change of the viscosity depends on the type of the thixotropic medium used, the predefined period of time is preferably adjustable depending on the type of thixotropic medium used. The device may therefore comprise a storage medium in which the combined information of the type of thixotropic medium and a respective predefined period of time is stored. Thus, an automatic starting of the kneading operation depending on the specific thixotropic medium used may be implemented. The storage medium may comprise a database with more than one set of combined information pertaining to more than one thixotropic medium usable with the device.

In a particularly preferred embodiment of the invention the kneading operation is performed during a downtime of a printing line incorporating at least one printing device according to the invention, whereas the downtime continues over a longer period of time than the interim time between the printing of two successive PCBs. Thus, the device may be adapted to print the thixotropic medium onto two or more PCBs successively with a predefined timing or method, whereas the predefined period of time after which a kneading operation is started is set longer than the timing, i.e. the interim time between the application of the thixotropic medium onto two successive PCBs.

Preferably, the printing device may be adapted to apply the thixotropic medium which is to be kneaded onto a surface area (which preferably does not include a surface of the PCB), in particular a surface area of a printing screen, whereas that surface area is adjacent to the screen image (i.e. the area comprising the screen apertures), by means of the printing head, whereas the printing head comprises at least one squeegee (and preferably more) and whereas the device is adapted to move the printing head in a reciprocal movement. The solder paste may then be dispersed on the surface area by means of the at least one squeegee during a first stroke of the reciprocal movement and at least a part of the solder paste may be compacted by means of the at least one squeegee during a second stroke of the reciprocal movement of the printing head. A respective embodiment of the method according to the invention is characterized in that the thixotropic medium, which is to be kneaded, is applied onto a surface area by means of the printing head, whereas the printing head comprises at least one squeegee and whereas the printing head is moved in a reciprocal movement with the solder paste being dispersed on the surface area by means of the at least one squeegee during a first stroke of the reciprocal movement and at least a part of the solder paste is compacted (again) by means of the at least one squeegee during a second stroke of the reciprocal movement. The surface area may in particular be a section of a surface of a printing screen. This embodiment of the invention allows for an easy and low-cost implementation of the kneading operation into a respective device being adapted to apply the thixotropic medium to the PCB by dispersing it on the surface of the PCB by means of at least one squeegee. In particular no additional hardware is necessary for implementing the invention into such a device. It may rather be sufficient to reprogram the control software of a controller of the printing device to implement the additional (kneading) action of the printing head.

A kneading operation performed by the device may comprise several reciprocal movements of the printing head in order to maintain the thixotropic medium in a required state of viscosity. The number of the reciprocal movements may depend in particular on the thixotropic medium used and the duration of the kneading operation. The same may be true for the speed with which the printing head is moved reciprocally. The kneading operation may in particular continue from the start of a downtime of a printing line (possibly delayed by the before mentioned predefined period of time) until the thixotropic medium is applied onto a subsequent PCB after the end of the downtime. In particular, the last stroke of the reciprocal movement of the printing head during the kneading operation may be followed directly by a printing stroke of the printing head in order to apply the thixotropic medium to a PCB. Alternatively, production still may not be called for and a downtime counter is reset to zero and timed again until a next kneading operation is triggered by the timer.

### BRIEF DESCRIPTION OF THE DRAWINGS

A preferred embodiment of the present invention will be described herein below by way of example only with reference to the accompanying drawings in which:

FIG. 1 illustrates schematically a printing device according to the invention in a printing line in a top view; and

FIGS. 2 to 6 illustrate schematically several steps during a kneading operation performed with the printing device according to FIG. 1.

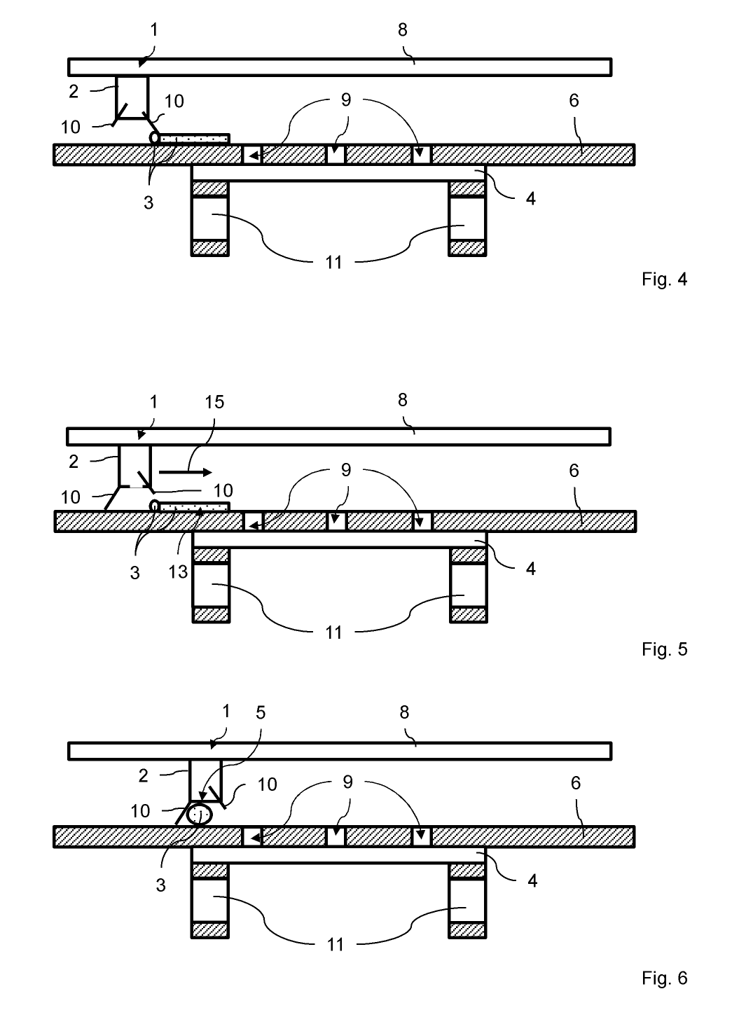

### DETAILED DESCRIPTION OF THE PREFERRED EMBODIMENT OF THE INVENTION

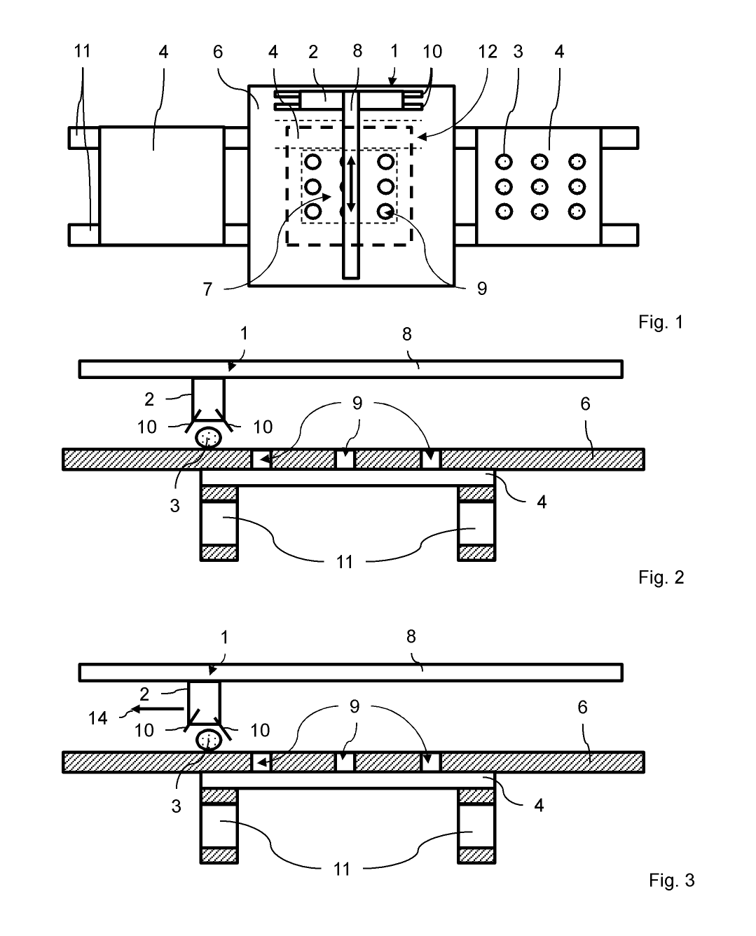

The printing device according to FIG. 1 is integrated into a printing line and comprises a printing head 1 including extractable squeegees 10. The squeegees 10 are held by a printing head base 2 which may incorporate actuators (not shown) for extending and retracting the squeegees 10. The PCBs 4, onto which the solder paste 3 is to be applied successively, are already provided with printed conductors (not shown). In a process following the application of the solder paste 3, electronic components such as resistors, capacitors, etc. (not shown) are soldered to respective contact areas of the PCBs 4. Applying discrete amounts of the solder paste 3 onto those contact areas of the PCBs 4 by means of the printing device, in particular the printing head 1, represents thus a first step in the soldering of the electronic components to the PCBs 4.

Applying the solder paste 3 onto the contact areas of the PCBs 4 is done in a conventional manner by dispensing a discrete amount of the solder paste 3 onto the top surface of a printing screen 6. Dispensing the solder paste 3 to the printing screen 6 may be done manually or by means of an automatic dispensing unit (not shown). Afterwards, the dispensed part of the solder paste 3 is dispersed over a screen image 7 of the printing screen 6 by means of the squeegees 10 during a reciprocal movement of the printing head 1 driven along a guide rail 8 by an internal drive (not shown). This will lead to the solder paste 3 entering through-holes 9 of the printing screen 6 situated within the screen image 7, thereby contacting the top surface of a PCB 4 lying underneath the printing screen 6 in the area of the screen image 7.

After the through-holes 9 of the screen image 7 have been filled completely with the solder paste 3, the PCB 4 lying underneath the printing screen 6 may be dropped from the printing screen 6 and the PCB 4 with the applied solder paste 3 in the contact areas may be transported by means of a conveyer 11 of the printing line away from the printing area. At the same time another PCB 4 may be transported into the printing area.

Due to the thixotropic characteristic of the solder paste 3, it may be easily dispersed by means of the printing head 1, because its viscosity will be relatively low due to the mechanical stress imparted when dispensing the solder paste 3 from the printing head 1 and when dispersing it by means of the squeegees 10. On the other hand, once the solder paste 3 is applied to a PCB 4 and has rested there for some time, its viscosity has increased sufficiently so that it will rest in place even though the printing screen 6 has been removed.

Nevertheless, the thixotropic characteristic of the solder paste 3 may have a negative effect in case of a downtime of the printing line. If the downtime lasts so long that there is a considerable increase in the viscosity of the solder paste 3 due to the interruption of the dispensing and dispersing action of the printing head 1, then dispersing of the solder paste 3 onto a PCB 4 after the end of the downtime may be adversely affected. This may lead to a lower quality of the distribution of the solder paste 3 and thus to low quality solder connections of the electronic elements with this PCB 4.

In order to avoid such a quality issue due to downtime of the printing line, the printing device is adapted to perform a kneading operation during such downtime, during which no application of solder paste 3 onto a PCB 4 is conducted. In particular, no PCB 4 needs to be present in the printing area during the kneading operation.

The kneading operation may be started after the lapse of a predefined period of time during which the printing head 1 was not used for applying solder paste 3 to a PCB 4. This predefined period of time may be monitored by means of a timer (not shown). The kneading area 12 is situated alongside the screen image 7 (cf. FIG. 1).

Further, the kneading operation comprises dispersing the solder paste 3 over the kneading area 12 to form a solder paste layer 13 with a reduced thickness compared to the thickness of the quantity of solder paste 3 before the dispersion. Dispersing the solder paste 3 imparts mechanical stress within the dispensed solder paste 3 and therefore avoids an increase of the viscosity of the dispensed solder paste 3.

Dispersing the solder paste 3 over the kneading area 12 is done in a first stroke, the flood stroke 14, of a reciprocal movement of the printing head 1 with the respective squeegee 10 extended and the other squeegee 10 retracted (cf. FIG. 4). The thickness of the solder paste layer 13 can be regulated by the level of extension of the respective squeegee 10.

The second stroke of the reciprocal movement, the knead stroke 15, leads to the dispersed solder paste 3 being compacted again by means of the two squeegees 10 being in the opposite extension/retraction statuses compared to the flood stroke 14 (cf. FIGS. 5 and 6). The pressure with which the extended squeegee 10 contacts the top surface of the printing screen 6 may be regulated by means of an extension/retraction drive (not shown) of the respective squeegee 10. It may preferably be lower than the pressure imparted during a regular printing stroke. Compacting the dispersed solder paste 3 will, again, impart mechanical stress within and therefore avoid an increase in the viscosity of the dispensed solder paste 3.

The kneading operation will be continued over a user-defined number of cycles, which the user has determined to be sufficient to maintain the required viscosity of the solder paste 3. Then the timer is reset and monitoring of the predefined period of time begins again. The last stroke 14, 15 of a reciprocal movement of the printing head 1 which is related to the kneading operation may then be followed by a stroke of the printing head 1, which is used to disperse solder paste 3 over the screen image 7 in order to apply it to a PCB 4 that is positioned underneath the printing screen 6. This can be done immediately as soon as a PCB 4 becomes available without having to delay the printing process. Due to the kneading operation of the printing device and thus due to the relatively low viscosity of the dispensed solder paste 3, it will be applied evenly in the through-holes 9 of the printing screen 6 and thus on the contact areas of the respective PCB 4. This should result in high quality soldering of electronic elements to the respective PCB 4.

The discussion and description of the figures above is only carried out by way of examples. Therefore, these examples describe, but do not limit the scope of the present invention.

List of Reference Characters Used:

1 Printing head

2 Printing head base

3 solder paste

2 PCB

6 printing screen

7 screen image

8 guide rail

9 through-holes

10 squeegee

11 conveyer

12 kneading area

13 solder paste layer

14 flood stroke

15 knead stroke

1. A device for printing a thixotropic medium onto a PCB, comprising a printing head adapted to apply the thixotropic medium to a surface of the PCB and a surface area where the thixotropic medium is locatable to be repeatably worked upon in a kneading operation during which at least a part of the thixotropic medium is kneaded while the printing head is not in use for applying the thixotropic medium onto the PCB.

2. The device according to claim 1, further comprising a timer which is adapted to activate a kneading operation after the lapse of a predefined period of time during which the printing head was not used for applying the thixotropic medium to a PCB.

3. The device according to claim 2, further comprising a storage medium in which the combined information of the type of thixotropic medium and a respective predefined period of time is stored.

4. The device according to claim 2, wherein the device is adapted to apply the thixotropic medium onto two or more PCBs successively with a predefined timing, whereas the predefined period of time after which a kneading operation is started is set longer than the timing between the application of the thixotropic medium onto two successive PCBs.

5. The device according to claim 1, wherein the device is adapted to apply the thixotropic medium to be kneaded onto the surface area by means of the printing head, whereas the printing head comprises at least one squeegee and whereas the device is adapted to move the printing head in a reciprocal movement, whereas the thixotropic medium is dispersed on the surface area by means of the squeegee during a first stroke of the reciprocal movement and at least part of the thixotropic medium is compacted by means of the squeegee during a second stroke of the reciprocal movement.

6. The device according to claim 5, wherein a kneading operation of the device comprises several reciprocal movements of the printing head.

7. A method for printing a thixotropic medium onto a PCB using a printing head adapted to apply the thixotropic medium to a surface of the PCB, wherein at least a part of the thixotropic medium is repeatedly worked upon at a surface area on which the thixotropic medium is locatable in a kneading operation while the printing head is not used for applying the thixotropic medium onto the PCB.

8. The method according to claim 7, wherein the kneading operation is started after the lapse of a predefined period of time during which the printing head was not used for applying the thixotropic medium to the PCB.

9. The method according to claim 8, wherein the predefined period of time is adjusted depending on the type of thixotropic medium used.

10. The method according to claim 7, wherein the thixotropic medium to be kneaded is applied onto a surface area by means of the printing head, and wherein the printing head comprises at least one squeegee and the printing head is moved in a reciprocal movement with the thixotropic medium being dispersed on the surface area by means of the squeegee during a first stroke of the reciprocal movement and at least parts of the thixotropic medium is compacted by means of the squeegee during a second stroke of the reciprocal movement.

11. The method according to claim 10, wherein the printing head is moved several times in a reciprocal movement during the kneading operation.
